(19) United States
(12) Patent Application Publication
(10) Pub. No.: US 2012/0132754 A1
(43) Pub. Date: May 31, 2012

(54) INTERFACE ARRANGEMENT BETWEEN TWO-COMPONENTS OF AN AIRCRAFT STRUCTURE

(75) Inventors: Jose Maria PINA LOPEZ, Alcorcon (ES); Nuria Rodrigo Caballero, Madrid (ES); Ignacio Outon Hernandez, Pinto (ES)

(73) Assignee: AIRBUS Operations S.L., Getafe (ES)

(21) Appl. No.: 13/071,853

(22) Filed: Mar. 25, 2011

(30) Foreign Application Priority Data
Nov. 30, 2010 (ES) 201031777

(51) Int. Cl. B64C 1/00

(52) U.S. Cl. 244/131

(57) ABSTRACT

Interface arrangement between a first component (11) and a second component (21) of an aircraft structure having an aerodynamic contour, such as a wing skin and a wing leading edge panel, the first component (11) having a joggle so that it includes a first area (13) which surface (15) belongs to the aircraft aerodynamic contour and a second area (17) where the joint with the second component (21) takes place, the second component (21) having a surface (23) belonging to the aircraft aerodynamic contour, in which the second component (21) includes a chamfer-shaped ending (29) that extends beyond the overlapping area (27) where the joint with the first component (11) takes place so that the gaps (26, 28) between the first component (11) and the second component (21) are minimized.

### FIELD OF THE INVENTION

This invention refers to an interface arrangement between two components of an aircraft structure having an aerodynamic contour and, more in particular, to an interface arrangement for maintaining the continuity of the aerodynamic contour in the interface.

### BACKGROUND OF THE INVENTION

As is well known, weight is a fundamental aspect in the aeronautic industry and therefore there is a current trend to use composite materials instead of metallic materials for aircraft structures with an aerodynamic contour such as lifting surfaces and fuselages.

The composite materials that are most used in the aeronautical industry consist of fibers or fiber bundles embedded in a matrix of thermosetting or thermoplastic resin, as a preimpregnated or “prepreg” material. Their main advantages refer to:
Their high specific strength with respect to metallic materials. It is the strength/weight equation.
Their excellent behavior before fatigue loads.
The possibilities of structural optimization due to the anisotropy of the material and the possibility of combining fibers with different orientations, allowing the design of the elements with different mechanical properties to be adjusted to the different needs in terms of applied loads.

The main structure for aircraft lifting surfaces consists of a leading edge, a torsion box, a trailing edge, a root joint and a tip. The torsion box consists of several structural elements: upper and lower skins stiffened by stringers on one side; spars and ribs on the other side. Typically, the structural elements forming the torsion box are manufactured separately and are joined with the aid of complicated tooling to achieve the necessary tolerances, which are given by the aerodynamic, assembly and structural requirements.

The interface between those components whose outer surface belongs to the aircraft aerodynamic contour such as a skin an a leading edge panel in the case of a lifting surface shall be arranged to comply with the aerodynamic requirements in terms of continuity, smoothness and drag, in the interface area.

In the prior art is well known the use of aerodynamic smoothing sealants covered by a paint layer to seal the gaps involved in said interfaces. These sealants are typically uncured pastes suitable for application by extrusion gun or spatula. They can cure at low temperatures and have a good adhesion to common aircraft substrates. However, when the gaps have certain dimensions the application and maintenance of said sealants raise several problems such as cracking, loosening or even detachment. These problems arise more often when the components joined are composite parts because their joints usually involve bigger gaps than metallic interfaces.

This invention is focused on the solution of this problem.

### SUMMARY OF THE INVENTION

One objective of the present invention is to provide a smoother interface arrangement between components of an aircraft structure with an aerodynamic contour that assures the continuity of the aerodynamic contour in that interface area, as well as an easy maintenance, filling the gap associated to the interface.

Another objective of the present invention is to provide an interface arrangement between components of an aircraft structure with an aerodynamic contour that assures the continuity of the aerodynamic contour in the interface area reducing significantly the amount of aerodynamic smoothing sealant applied to seal the gap associated to the interface and allowing a weight reduction.

These and other objectives are met by an interface arrangement between a first component and a second component of an aircraft structure having an aerodynamic contour, the first component having a joggle so that it includes a first area which surface belongs to the aircraft aerodynamic contour and a second area where the joint with the second component takes place, the second component having a surface belonging to the aircraft aerodynamic contour, in which the second component includes a chamfer-shaped ending that extends beyond the overlapping area where the joint with the first component takes place so that the gaps between the first component and the second component are minimized.

In a preferred embodiment said chamfer-shaped ending has a straight-shaped tip having preferably a minimum width of 0.5 mm and a length comprised between 8-12 mm. Hereby it is achieved an interface arrangement with very small remaining gaps between both components.

In another preferred embodiment the remaining gaps are filled with an aerodynamic smoothing sealant. Hereby it is achieved an interface arrangement where the continuity of the aerodynamic contour in the interface area can be easily assured.

One particular field of application of the present invention is the interface between a skin and a leading edge panel or a trailing edge panel in an aircraft lifting surface such as a wing or an horizontal tail plane.

Another particular field of application of the present invention is the interface between circumferential sections of an aircraft fuselage.

This invention is applicable to interfaces between composite parts and also to interfaces between metallic parts.

Other characteristics and advantages of the present invention will be clear from the following detailed description of embodiments illustrative of its object in relation to the attached figures.

### BRIEF DESCRIPTION OF DRAWINGS

FIG. 1 is a section side view of an interface arrangement between a wing skin and a wing leading edge panel showing a gap between their aerodynamic surfaces.

FIG. 2 is a section side view of an interface arrangement between a wing skin and a wing leading edge panel according to a preferred embodiment of this invention.

FIG. 3 is a detailed view of area A in FIGS. 2.

### DETAILED DESCRIPTION OF THE INVENTION

A detailed description of the invention for an interface arrangement between a wing skin and a wing leading edge panel follows.

The main structure for aircraft lifting surfaces consists of a leading edge, a torsion box, a trailing edge, a root joint and a tip. A torsion box structurally consists of spars, ribs and upper and lower skins with several stringers. The upper and lower skins are joined to the leading edge and the trailing edge panels forming the upper and lower wing aerodynamic contour.

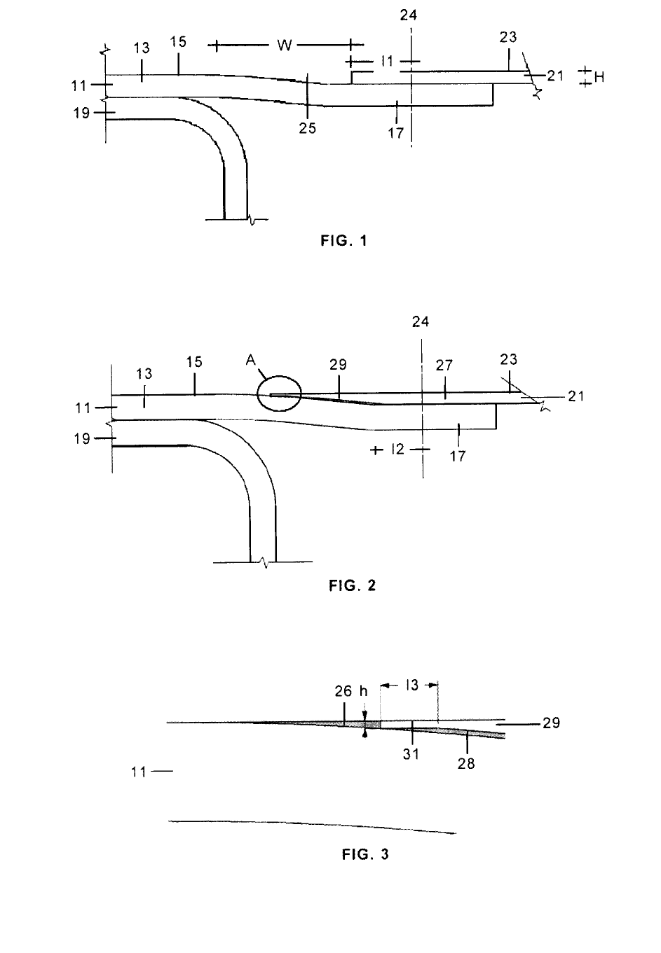

FIG. 1 shows the typical interface arrangement between a wing skin 11 which extends forward the front spar 19 and a wing leading edge panel 21. The wing skin 11 is joggled so that the surface 15 of the first area 13 belongs to the wing aerodynamic contour and the second area 17 is the area where the joint with the leading edge panel 21 is carried out by means of, usually, at least one row of fasteners placed in the position indicated by the line 24 at, usually, a distance l1=2.5 D plus tolerances from the edge of the leading edge panel 21, being D the diameter of one fastener. The surface 23 of the leading edge panel 21 also belongs to the wing aerodynamic contour.

This interface arrangement creates a gap 25 of width W and height H which can not be sealed satisfactorily using an aerodynamic smoothing sealant when H is bigger than 10 mm. On the other hand, said sealant raise several maintenance problems due to certain defects (particularly cracking) or to its detachment from the wing skin 11.

According to the present invention, as shown in FIG. 2, the leading edge panel 21 is configured with a chamfer-shaped ending 29 that extends beyond the overlapping area 27 where the joint with the wing skin 11 takes place so that the gap between the wing skin 11 and the leading edge panel 21 is brought to the minimum to fit assembly tolerances.

Said chamfer-shaped ending 29 provides, with respect to the interface arrangement shown in FIG. 1, an increase of the effective area of the leading edge panel 21 from a stress calculation point of view that allows the row of fasteners used for the joint of both components to be moved closer to the front spar 19 to the position indicated by the line 24 in FIG. 2 at a distance l2=1.5 D+1 from the beginning of the chamfer-shaped ending 29, being D the diameter of one fastener. This allows the design to decrease the dimension of the joggled area 17 of the wing skin 11 and therefore its weight.

In a preferred embodiment shown in FIG. 3, said chamfer-shaped ending 29 finishes with an straight-shaped tip 31 of a length l3 comprised preferably between 8-12 mm so that the gaps 26, 28 between the components 11, 21 can be reduced to the minimum for a better adjustment to their surfaces. Said tip 31 shall have a minimum width of 0.5 mm due to manufacturing requirements (two plies in the case of a composite part). This way, particularly the remaining gap 26 between the wing skin 11 and the leading edge panel 21, which height h is very small now, can be easily filled with an aerodynamic smoothing sealant.

The weight reduction of the wing skin 11 together with the weight reduction due to the decrease in the quantity of aerodynamic smoothing sealant used is an important advantage of the present invention with respect to the prior art.

Another advantage of the present invention is that the assembly of the leading edge panel 21 to the wing skin 11 is easier due to the small volume of the remaining gaps 26, 28 that shall be filled with an aerodynamic smoothing sealant.

Although the present invention has been fully described in connection with preferred embodiments, it is evident that modifications may be introduced within the scope thereof, not considering this as limited by these embodiments, but by the contents of the following claims.

1. Interface arrangement between a first component (11) and a second component (21) of an aircraft structure having an aerodynamic contour, the first component (11) having a joggle so that it includes a first area (13) which surface (15) belongs to the aircraft aerodynamic contour and a second area (17) where the joint with the second component (21) takes place, the second component (21) having a surface (23) belonging to the aircraft aerodynamic contour, characterized in that the second component (21) includes a chamfer-shaped ending (29) that extends beyond the overlapping area (27) where the joint with the first component (11) takes place so that the gaps (26, 28) between the first component (11) and the second component (21) are minimized.

2. Interface arrangement according to claim 1, wherein said chamfer-shaped ending (29) has a straight-shaped tip (31).

3. Interface arrangement according to claim 2, wherein the minimum width of said straight-shaped tip (31) is 0.5 mm and its length is comprised between 8-12 mm.

4. Interface arrangement according to any of claims 1-3, wherein an aerodynamic smoothing sealant is used for sealing the remaining gaps (26, 28) between said first and second components (11, 21).

5. Interface arrangement according to any of claims 1-4, wherein said first and second components (11, 21) are composite parts.

6. Interface arrangement according to any of claims 1-4, wherein said first and second components (11, 21) are metallic parts.

7. Interface arrangement according to any of claims 1-6, wherein said aircraft structure is a lifting surface.

8. Interface arrangement according to claim 7, wherein said first component (11) is a skin and said second component (21) is a leading edge panel.

9. Interface arrangement according to claim 7, wherein said first component (11) is a skin and said second component (21) is a trailing edge panel.

10. Interface arrangement according to any of claims 1-6, wherein said aircraft structure is a fuselage.

11. Interface arrangement according to claim 10, wherein said first and second components (11, 21) are skin circumferential sections.
